(19) United States
(12) Patent Application Publication
(10) Pub. No.: US 2007/0074230 A1
(43) Pub. Date: Mar. 29, 2007

(54) Optical disc recording and/or reproducing apparatus and optical pickup cooling method of optical disc recording and/or reproducing apparatus

(75) Inventors: Akiko Yaoita, Kanagawa-ken (JP); Shinichi Tatsuta, Tokyo (JP); Masatoshi Hirono, Kanagawa-ken (JP); Hideki Ito, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/510,581

(22) Filed: Aug. 28, 2006

(30) Foreign Application Priority Data
Sep. 13, 2005 (JP) 2005-265828

(51) Int. Cl. G11B 17/04

(52) U.S. Cl. 720/628; 720/646

(57) ABSTRACT

An optical disc recording and/or reproducing apparatus in which an opening is provided on a cabinet and a disc tray provided with a through portion is supported so as to be capable of reciprocating so that the opening can be opened and closed. The disc tray is provided with a shutter which is positioned to open at least a part of the through portion when the opening is in the closed state. The shutter is positioned to close at least a part of the opened through portion when the opening is changed from the closed state to the opened state. Accordingly, by such structure and methodology, increase in temperature of the components mounted on an optical pickup can be reduced.

### CROSS-REFERENCE TO RELATED APPLICATIONS

This application is based upon and claims the benefit of priority from the prior Japanese Patent Application No. 2005-265828, filed Sep. 13, 2005, the entire contents of which are incorporated herein by reference.

### BACKGROUND OF THE INVENTION

1. Field of the Invention

The present invention relates to an optical disc recording and/or reproducing apparatus and an optical pickup cooling method of the optical disc recording and/or reproducing apparatus.

2. Description of the Related Art

An optical disc recording and/or reproducing apparatus used for recording or reproducing information to/from an optical disc such as a digital versatile disc (DVD) or a compact disc (CD) includes an optical pickup on which components such as a laser diode and a laser driver are mounted. In addition, a moving unit for reciprocating the optical pickup radially of the optical disc and a drive unit for rotating the optical disc are integrated therein.

In recent years, prevention of lowering of performance, deterioration of lifetime, and erroneous operation caused by rise in temperature of components such as the laser diode and the laser driver has become problematic upon downsizing of the optical disc recording and/or reproducing apparatus and increasing the recording or reproducing speed.

In order to do so, in that context, the negative pressure generated at a center portion of the optical disc when the optical disc is rotated in the optical disc recording and/or reproducing apparatus has recently become a point of consideration. Taking advantage of that negative pressure, it has been disclosed to install a guiding unit for guiding cooling air toward the center of the optical disc. The components are then arranged on an air-introducing channel route of the cooling air. Accordingly, the components including the optical pickup are cooled without providing a fan. (See Japanese Patent Application (Publication) No. 2000-173259).

In another optical disc recording and/or reproducing apparatus in the related art, an interior of a cabinet is divided into a disc chamber for storing the optical disc and a machine chamber for storing the components. One opening is provided on a tray at a position corresponding to the center of the optical disc placed thereon, and another opening is provided on a side wall of the tray. With the provision of these two openings, air in the optical disc recording and/or reproducing apparatus is circulated around the optical pickup for cooling the components (See Japanese Patent Application (Publication) No. 2004-127467).

In still another optical disc recording and/or reproducing apparatus in the related art, a pair of openings is provided on a tray at positions which correspond to an outer periphery of the optical disc with a slit provided therebetween. A lid is arranged on the openings so as to be capable of opening and closing freely. When the optical pickup is moved toward the outer periphery of the optical disc, the optical pickup and the lid are engaged with respect to each other. With this engagement, the movement of the optical pickup is transmitted to the lid. As a result of transmission of the movement, the lid opens. In association therewith, outside air is introduced through the openings to cool the optical pickup (see Japanese Patent Application (Publication) No. 2004-342160).

However, the optical disc recording and/or reproducing apparatus disclosed in Japanese Patent Application (Publication) No. 2000-173259 requires the air-introducing channel for using air flow generated by the rotation of the optical disc for cooling the components. Therefore, it is difficult to apply such an air-introducing channel to a low-profile optical disc recording and/or reproducing apparatus, generally called as “slim drive,” used for compact computers such as notebook computers or a compact DVD recording/reproducing apparatus.

On the other hand, in the case of the optical disc recording and/or reproducing apparatus disclosed in Japanese Patent Application (Publication) No.2004-127467, a further opening is formed on the side wall. However, in the case of the low-profile optical disc recording and/or reproducing apparatus, the height of the side wall is very small in order to realize its low-profile. Therefore, a sufficient amount of air cannot be circulated, and hence the effect of cooling the optical pickup is insufficient.

In the case of the optical disc recording and/or reproducing apparatus disclosed in Japanese Patent Application (Publication) No. 2004-342160, the movement of the optical pickup is transmitted to the lid. Therefore, when the optical pickup is moved toward the outer peripheral side of the optical disc, a force to move the optical pickup is increased. Therefore, a significant load is applied to a supporting mechanism for movably supporting the optical pickup and the moving unit. As a result, the positional accuracy of the optical pickup may be affected, and in addition, an increase in size of the moving unit may result.

### SUMMARY OF THE INVENTION

In view of such circumstances as above described, it is an object of the present invention to provide a compact optical disc recording and/or reproducing apparatus in which rise in temperature of components mounted on an optical pickup is alleviated, and an optical pickup cooling method of the optical disc recording and/or reproducing apparatus.

Accordingly, according to one aspect of the present invention, there is provided an optical disc recording and/or reproducing apparatus including: a cabinet provided with an opening; an opening/closing unit configured to open and close the opening; a disc tray provided with a through portion at a part thereof; an optical disc driving unit configured to rotate an optical disc on one of the surfaces of the disc tray at a predetermined distance from the disc tray; an optical pickup reciprocatingly movable on the side of the other surface of the disc tray and configured to irradiate an optical beam to the optical disc and to detect a reflected beam therefrom; and a shutter configured to cover at least a part of the through portion, wherein the shutter is configured to perform a movement to cover at least a part of the through portion so as to cover at least a part of the optical pickup or a movement to open at least a part of the covered through portion according to the opened/closed state of the opening.

According to another aspect of the present invention, there is provided an optical pickup cooling method of an optical disc recording and/or reproducing apparatus as above described, including: covering at least a part of a through portion with a shutter so as to cover at least a part of the optical pickup or to open at least a part of the covered through portion according to the opened/closed state of the opening.

### BRIEF DESCRIPTION OF THE SEVERAL VIEWS OF THE DRAWINGS

A more complete appreciation of the invention and many of the attendant advantages thereof will be readily obtained as the same better understood by reference to the following detailed description when considered in connection with the accompanying drawings, wherein:

FIG. 1 is a perspective view showing an optical disc recording and/or reproducing apparatus according to a first embodiment of the invention;

FIG. 2 is a partly enlarged drawing showing an interior of the optical disc recording and/or reproducing apparatus according to the first embodiment of the invention;

FIG. 3 is a drawing showing the optical disc recording and/or reproducing apparatus according to the first embodiment of the invention;

FIG. 4 is a drawing showing the optical disc recording and/or reproducing apparatus according to a second embodiment of the invention; and

FIG. 5 is a perspective view showing the optical disc recording and/or reproducing apparatus according to a third embodiment of the invention.

### DETAILED DESCRIPTION OF THE INVENTION

Referring now to the drawings, wherein like reference numerals are used to designate the same or corresponding parts throughout the several views, embodiments of the invention will be described.

### First Embodiment

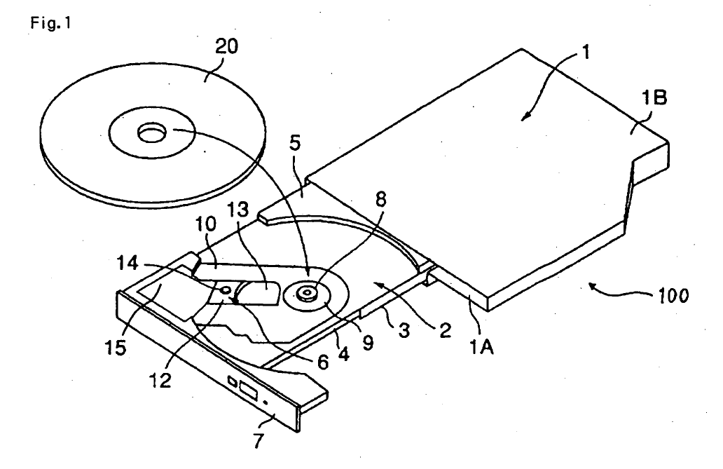

FIG. 1 is a perspective view of an optical disc recording and/or reproducing apparatus according to a first embodiment of the invention. In FIG. 1, a shutter, which will be described later, is not shown in the drawing for convenience of illustration.

FIG. 1 shows a slim type optical disc recording and/or reproducing apparatus 100 in a state in which a disc tray 2 is drawn out from a cabinet 1.

The cabinet 1 is provided with an opening in the direction in which the disc tray 2 is drawn out and is formed into a box shape. The cabinet 1 includes a bottom cabinet 1A and a top plate portion 1B to be fixed so as to cover the bottom cabinet 1A. In a back surface portion of the cabinet 1, a PC board (circuit board) for controlling a disc device, not shown, a flexible cable connected to the PC board, a solenoid, and other mechanisms are stored and retained.

Slide holders, not shown, are provided on both side surfaces of the interior of the bottom cabinet 1A, respectively. A slide 3 is slidably retained by the slide holders. The slide 3 is slidably retained also by slide holders 4 provided on both side surfaces of the disc tray 2 in the same manner. The disc tray 2 is provided between the slide holders 4. In this manner, the disc tray 2 is supported by a sliding mechanism (slide rail) having the slide 3 and the slide holders 4 so as to be capable of reciprocating with respect to the cabinet 1.

The disc tray 2 includes a mechanism unit 6 mounted in a drawer frame 5 via a cushion, not shown, for absorbing vibrations, and the bottom portion thereof is covered by a drawer cover. A front vessel plate 7 is mounted to a front surface of the drawer frame 5 and is shaped to close an opening formed on the cabinet 1. In this manner, an opening/closing mechanism having the sliding mechanism and the front vessel plate 7 is provided so as to open and close the opening provided on the cabinet 1.

The mechanism unit 6 is provided with a chassis 10. The chassis 10 is provided with an optical disc driving unit, including a spindle, a hub 8 and a turn table 9 described later. A disc motor unit is fixed to the chassis 10. The spindle of the disc motor unit (described later) is provided with the hub 8 and the turn table 9. The hub 8 and the turn table 9 are provided for retaining an optical disc 20 and rotating the optical disc 20. The optical disc 20 is driven into rotation by the optical disc driving unit on a surface of the disc tray 2 on the side of the top plate portion 1B (one of the surfaces).

The chassis 10 is provided with a square shaped hole 13 over a range in which an optical pickup head 12 moves. A hole 15 having a width wider than that of the hole 13 is provided over a range across the chassis 10 and the drawer frame 5. A through portion composed of the hole 13 and the hole 15 is provided so that an objective lens 14 of the optical pickup head 12 can be exposed therethrough. The hole 15 is provided so that at least a part of the remaining portion of the optical pickup head 12 can also be exposed therethrough in addition to the objective lens 14.

The optical pickup head 12 is supported so as to be capable of reciprocating on a surface of the chassis 10 on the side of the drawer cover (the other surface) by the optical pickup shaft, described later, mounted to the chassis 10. In the chassis 10, a feed motor and a gear mechanism (both not shown) for moving the optical pickup head 12 are further provided. The optical pickup head 12, the disc motor unit, the feed motor, and so on are connected to the flexible cable which is connected to the PC board.

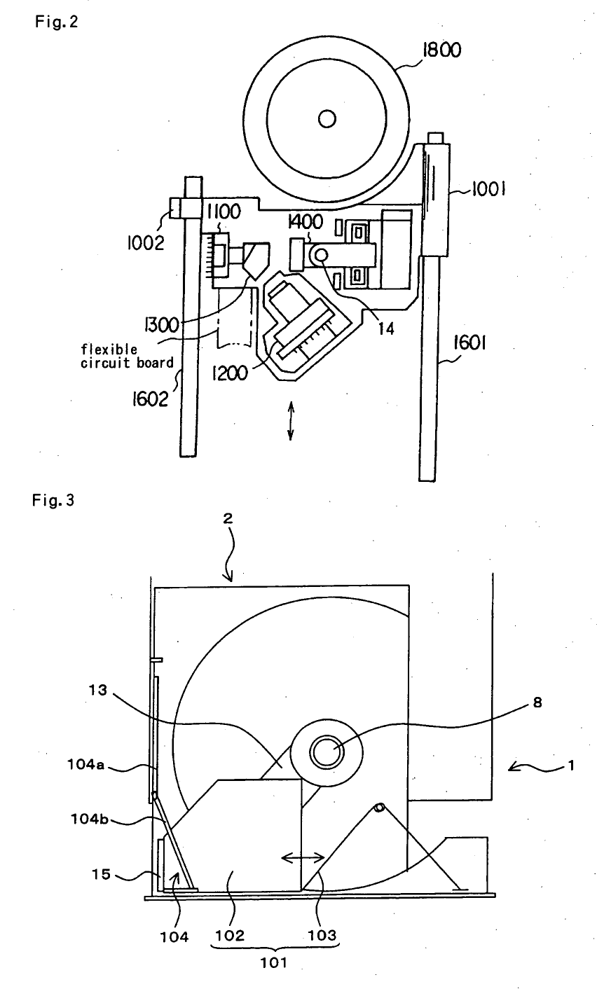

FIG. 2 is a drawing showing the interior of the optical disc recording and/or reproducing apparatus 100 according to the first embodiment of the invention in a partly enlarged scale.

The optical pickup head 12 includes a first optical module 1100, a second optical module 1200, wavelength-selective reflecting device 1300, a launching device 1400, an objective lens 14 and a disc motor unit 1800.

The first optical module 1100 is an optical module for a compact disc (CD), and the second optical module 1200 is an optical module for a digital versatile disc (DVD).

The first optical module 1100 includes a first semiconductor laser, a first diffracting device, a first light receiving element, and a first I/O terminal unit. A first laser beam is emitted from the first semiconductor laser according to a signal applied from the first I/O terminal unit. The first laser beam irradiated on the optical disc 20 and reflected therefrom is diffracted by the first diffracting device and received by the first light-receiving element. An electric signal from the first light-receiving element is outputted from the first I/O terminal unit.

The second optical module 1200 includes a second semiconductor laser, a second diffracting device, a second light-receiving element, and a second I/O terminal unit on a second substrate having a flat portion. A second laser beam having a shorter wavelength than the first laser is emitted from the second semiconductor laser according to a signal applied from the second I/O terminal unit. The second laser beam irradiated on the optical disc and reflected therefrom is diffracted by the second diffracting device and received by the second light-receiving element. The electric signal from the second light-receiving element is outputted from the second I/O terminal unit.

The wavelength-selective reflecting device 1300 allows the first laser beam to pass therethrough and reflects the second laser beam. The launching device 1400 emits the first or the second laser beam toward the objective lens 14. Light reflected from the optical disc 20 is introduced toward the wavelength-selective reflecting device 1300. The objective lens 14 irradiates a laser beam from the launching device 1400 to the optical disc 20. A focus of the objective lens 14 is controlled by a focus controlling device, not shown.

A disc motor unit 1800 is provided for generating a drive force for driving the optical disc 20 into rotation. The spindle of the disc motor unit 1800 is provided with the hub 8 and the turn table 9 as described above.

The chassis 10 is provided with optical pickup shafts 1601, 1602. The optical pickup shafts 1601, 1602 are provided so as to extend in parallel to each other. The optical pickup shafts 1601, 1602 are provided with the objective lens 14. The objective lens 14 is provided so as to be capable of moving in parallel to the optical disc 20 radially of the optical disc 20.

Engaging sections 1001, 1002 provided on the optical pickup head 12 supports the optical pickup head 12 so as to be capable of reciprocating with respect to the optical pickup shafts 1601, 1602. Accordingly, the objective lens 14 can move in parallel to the optical disc 20 radially of the optical disc 20.

FIG. 3 is a drawing showing the optical disc recording and/or reproducing apparatus 100 according to the first embodiment of the invention. In FIG. 3, the optical disc 20 and the top plate portion 1B are not shown for the convenience of illustration.

The disc tray 2 is provided with a shutter 101, which includes a shutter plate 102 and a resilient supporting member 103. The shutter plate 102 is supported in a state of being capable of reciprocating in the direction of a recording surface of the optical disc 20. The shutter plate 102 is provided so as to cover at least a part of the hole 13 and at least a part of the hole 15. The shutter plate 102 is supported so as to open at least part of the covered holes 13 and 15 when the shutter plate 102 is reciprocated.

The resilient supporting member 103 is provided so as to urge the shutter plate 102 in the direction to cover at least a part of the hole 13 and at least a part of the hole 15. The resilient supporting member 103 may be, for example, a torsion spring as shown in FIG. 3.

The disc tray 2 is provided with a displacement transmitting device 104, which may be, for example, a link mechanism as shown in FIG. 3. When the link mechanism is used for the displacement transmitting device 104, the displacement transmitting device 104 includes a first link 104a and a second link 104b. The first link 104a and the second link 104b are connected so as to be capable of bending at a joint portion thereof by at least one degree of flexibility.

The first link 104a is provided so that an end on the opposite side from the joint portion with respect to the second link 104b engages with a part of the cabinet 1. The first link 104a is provided so as to be pressed by the cabinet 1 at the time of reciprocating movement of the disc tray 2 which opens and closes the opening of the cabinet 1.

The second link 104b is provided so that an end on the opposite side from the joint portion with respect to the first link 104a engages a part of the disc tray 2. The second link 104b is provided so as to be connected, for example, with a part of the disc tray 2. The joint portion is provided so that the second link 104b can rotate by at least one degree of flexibility.

The displacement transmitting device 104 transmits displacement of the disc tray 2 in the closing direction with respect to the cabinet 1 to the shutter plate 102 when the opening of the cabinet 1 is closed by the disc tray 2. The displacement transmitting device 104 moves the shutter plate 102 in the direction against an urging force of the resilient supporting member 103. The shutter plate 102 opens at least a part of the hole 13 and the hole 15 covered by the shutter plate 102 as a result of movement of the shutter plate 102.

When the opening of the cabinet 1 is opened by the disc tray 2, a force of the cabinet 1 pressing the first link 104a is released. Then, the shutter plate 102 moves in the direction opposite from the case of closing the opening of the cabinet 1 by the urging force of the resilient supporting member 103.

The optical disc recording and/or reproducing apparatus 100 configured in this manner is provided with the hole 15 having a wider width than the hole 13 provided in the range of movement of the optical pickup head 12. The hole 15 is provided so that at least a part of the remaining portion of the optical pickup head 12 can also be exposed therethrough in addition to the objective lens 14. Therefore, when the optical disc 20 is rotated, much air in the optical disc recording and/or reproducing apparatus 100 can be circulated around the optical pickup head 12. Therefore, such air circulation contributes to cool the heat-generating components provided on the optical pickup head 12, in particular, the second optical module 1200 which generate a large amount of heat, and thus a rise in temperature of components can be alleviated.

In a state in which the opening of the cabinet 1 is opened and the optical disc 20 can be set, at least a part of the hole 13 and the hole 15 is covered by the shutter plate 102. Accordingly, at least a part of the optical pickup head 12, in particular, a part which is fragile against an external force can be protected. Therefore, when a user sets or takes out the optical disc 20, the optical pickup head 12 is prevented from being damaged by erroneous contact to the optical pickup head 12 or impingement of the optical disc 20.

In a state in which the opening of the cabinet 1 is opened and the optical disc 20 can be set, at least a part of the hole 13 and at least a part of the hole 15 are covered by the shutter plate 102. Accordingly, erroneous contact to the objective lens 14 by the user can be prevented. Therefore, the objective lens 14 is prevented from being mistakenly contaminated by a finger print or the like when the user sets or takes out the optical disc 20.

In this embodiment, the positional relation between the hole 13 and the hole 15 is not specifically defined. However, as shown in FIG. 1, it is preferable to provide the hole 13 and the hole 15 so that the wider hole 15 is located on the outer peripheral side of the optical disc 20 than the hole 13 provided over the range of movement of the optical pickup head 12.

This is because most of the optical discs 20 are configured to perform reproduction or recording from the inner peripheral side to the outer peripheral side. When the reproduction or recording is started from the inner peripheral side, the temperature of the components of the optical pickup head 12 is not very high. However, when the reproduction or recording is continued for a long time, the optical pickup head 12 is moved toward the outer peripheral side. In that state, the components of the optical pickup head 12 are in a state of having continuously generated heat. Therefore, the temperature of the optical pickup head 12 at the outer peripheral side tends to be higher than at the inner peripheral side from which the reproduction or recording is started.

Therefore, it is preferable to provide the hole 13 and the hole 15 so that the hole 15 is located on the outer peripheral side of the optical disc 20 than the hole 13, as described above. In such a configuration, a larger amount of air can be circulated around the optical pickup head 12 when the reproduction or recording on the outer peripheral side of the optical disc 20 where the temperature of the optical pickup head 12 is higher.

In this embodiment, a case in which the shape of the shutter plate 102 is pentagon is described. However, the shape of the shutter plate 102 is not limited thereto, and any shape is applicable as long as at least a part of the hole 13 and the hole 15 can be covered.

In this embodiment of the invention, the movement of the shutter plate 102 is realized by transmitting the displacement between open and close of the opening of the cabinet 1. However, it can be realized by combining, for example, a temperature sensor or an actuator. In this case, when the temperature of the optical pickup head 12 exceeds a threshold value, the components provided on the optical pickup head 12 can be cooled by opening the shutter plate 102.

In addition, when opening the shutter plate 102 by an actuator, for example, it can be configured in such a manner that the shutter plate 102 is opened only when a significant amount of heat is generated in the components provided on the optical pickup head 12, for example, only when writing in the DVD.

### Second Embodiment

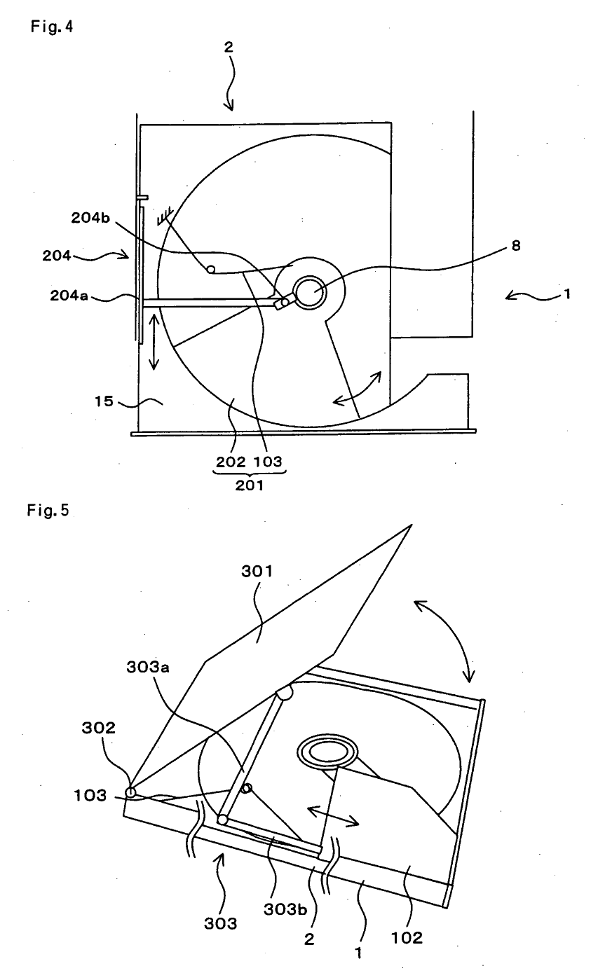

FIG. 4 is a drawing showing the optical disc recording and/or reproducing apparatus according to a second embodiment of the invention. The optical disc 20 and the top plate portion 1B are not shown for the convenience of description in FIG. 4. The same parts as the optical disc recording and/or reproducing apparatus according to the first embodiment of the invention are represented by the same reference numerals and description will be omitted.

In this embodiment, as shown in FIG. 4, the shutter plate 102 is moved using a displacement transmitting device other than the link mechanism instead of the displacement transmitting device 104 in which the link mechanism is employed in the first embodiment. The disc tray 2 is provided with a shutter 201. The shutter 201 includes a shutter plate 202 and the resilient supporting member 103. The shutter plate 202 is supported so as to be capable of rotating in the direction of rotation of the optical disc 20. The shutter plate 202 is provided so as to cover at least a part of the hole 13 and at least a part of the hole 15. The shutter plate 202 is supported so as to open at least a part of the hole 13 and the hole 15 which is in the covered state when the shutter 202 is rotated.

The disc tray 2 is provided with displacement transmitting device 204, which includes a displacement transmitting member 204a provided so that at least a part thereof engages with a part of the cabinet 1. The displacement transmitting member 204a is provided so as to be pressed by the cabinet 1 when the disc tray 2 reciprocates to open and close the opening of the cabinet 1.

The displacement transmitting member 204a and the shutter plate 202 are connected by a joint portion 204b so that the displacement transmitting member 204a can be rotated with respect to the shutter plate 202. The joint portion 204b is provided at a position where the linear displacement of the disc tray 2 to open and close the opening of the cabinet 1 can be converted into rotational displacement of the shutter plate 202.

The optical disc recording and/or reproducing apparatus configured in this manner is provided with the hole 15 having a wider width than the hole 13 provided over the range of movement of the optical pickup head 12 in the same manner as the optical disc recording and/or reproducing apparatus according to the first embodiment. The hole 15 is configured so that at least a part of the remaining portion of the optical pickup head 12 can also be exposed therethrough in addition to the objective lens 14. Therefore, when the optical disc 20 is rotated, a large amount of air in the optical disc recording and/or reproducing apparatus can be circulated around the optical pickup head 12. Therefore, the circulated air contributes to cooling of the heat-generating components provided on the optical pickup head 12, in particular the second optical module 1200 which generates a significant amount of heat, and rise in temperature of the components can be alleviated.

In a state in which the opening of the cabinet 1 is opened and the optical disc 20 can be set, at least a part of the hole 13 and the hole 15 is covered by the shutter 102. Accordingly, at least a part of the optical pickup head 12, in particular a part of the optical pickup head 12 which is fragile against an external force, can be protected. Therefore, when the user sets or takes out the optical disc 20, the optical pickup head 12 is prevented from being damaged by erroneous contact to the optical pickup head 12 or impingement of the optical disc 20.

In a state in which the opening of the cabinet 1 is opened and the optical disc 20 can be set, at least a part of the hole 13 and the hole 15 is covered by the shutter plate 102. Accordingly, erroneous contact to the objective lens 14 by the user can be prevented. Therefore, the objective lens 14 is prevented from being mistakenly contaminated by finger print or the like when the user sets or takes out the optical disc 20.

### Third Embodiment

FIG. 5 is a perspective view showing the optical disc recording and/or reproducing apparatus according to a third embodiment of the invention. In FIG. 5, the optical disc 20 is not shown in the drawing for the convenience of description. The same parts as the optical disc recording and/or reproducing apparatus according to the first embodiment and the second embodiment of the invention are represented by the same reference numerals and description will be omitted.

In this embodiment, an opening/closing mechanism having a cover 301 is used instead of the sliding mechanism and the opening/closing mechanism having the front vessel plate 7 in the first embodiment.

The cabinet 1 is provided with the cover 301. The cover 301 is rotatably supported by the cabinet 1 by the use of a hinge 302. The opening of the cabinet 1 is opened and closed by the cover 301 by the rotational movement of the cover 301.

The cover 301 and the shutter plate 102 are connected by the use of a displacement transmitting device 303, including a first link 303a and a second link 303b. The first link 303a is connected at one end to the cover 301 in a rotatable state. The second link 303b is fixed at one end to the shutter plate 102. The other end of the second link 303b is connected to the other end of the first link 303a. A joint portion between the first link 303a and the second link 303b is connected so as to be capable of bending by at least one degree of flexibility.

The resilient supporting member 103 is provided so as to urge the shutter plate 102 in the direction to cover at least a part of the hole 13 and at least a part of the hole 15 via the second link 303b.

The optical disc recording and/or reproducing apparatus configured in this manner is provided with the hole 15 having a wider width than the hole 13 provided over the range of movement of the optical pickup head 12 as in the case of the optical disc recording and/or reproducing apparatus in the first embodiment. The hole 15 is configured so that at least a part of the remaining portion of the optical pickup head 12 can also be exposed therethrough in addition to the objective lens 14. Therefore, when the optical disc 20 is rotated, a large amount of air in the optical disc recording and/or reproducing apparatus can be circulated around the optical pickup head 12. Therefore, the circulated air contributes to cool the heat-generating components provided on the optical pickup head 12, in particular the second optical module 1200 which generates a significant amount of heat, and rise in temperature of the components can be alleviated.

In a state in which the opening of the cabinet 1 is opened and the optical disc 20 can be set, at least a part of the hole 13 and the hole 15 are covered by the shutter plate 102. Accordingly, at least a part of the optical pickup head 12, in particular a part of the optical pickup head 12 which is fragile against an external force, can be protected. Therefore, when the user sets or takes out the optical disc 20, the optical pickup head 12 is prevented from being damaged by erroneous contact to the optical pickup 12 head or impingement of the optical disc 20.

In a state in which the opening of the cabinet 1 is opened and the optical disc 20 can be set, at least a part of the hole 13 and the hole 15 are covered by the shutter plate 102. Accordingly, erroneous contact to the objective lens 14 by the user can be prevented. Therefore, the objective lens 14 is prevented from being mistakenly contaminated by a finger print or the like when the user sets or takes out the optical disc 20.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An optical disc recording and/or reproducing apparatus comprising:
a cabinet provided with an opening;
an opening/closing unit configured to open and close the opening;
a disc tray provided with a through portion at a part thereof;
an optical disc driving unit configured to rotate an optical disc on one of the surfaces of the disc tray at a predetermined distance from the disc tray;
an optical pickup reciprocatingly movable on the side of the other surface of the disc tray and configured to irradiate an optical beam to the optical disc and to detect a reflected beam through the through portion; and
a shutter configured to cover at least a part of the through portion,
wherein the shutter is movable to shield at least a part of the through portion so as to cover at least a part of the optical pickup or to open at least a part of the shielded through portion according to the opened/closed state of the opening.

2. The optical disc recording and/or reproducing apparatus according to claim 1, wherein the shutter is configured to perform a movement to shield at least a part of the through portion so as to cover at least a part of the optical pickup when the opening is in the opened state and a movement to open at least a part of the shielded through portion when the opening is in the closed state.

3. The optical disc recording and/or reproducing apparatus according to claim 1, further comprising:
a displacement transmitting unit configured to transmit displacement of the opening and closing movement done by the opening/closing unit to the shutter.

4. The optical disc recording and/or reproducing apparatus according to claim 1, further comprising:
an urging unit configured to urge the shutter in a direction to shield at least a part of the through portion.

5. The optical disc recording and/or reproducing apparatus according to claim 1, wherein the opening/closing unit comprises:
a slide rail configured to support the disc tray so as to be capable of reciprocating with respect to the cabinet.

6. The optical disc recording and/or reproducing apparatus according to claim 1, wherein the opening/closing unit comprises:
a cover configured to open and to close the opening.

7. The optical disc recording and/or reproducing apparatus according to claim 1, further comprising:
an actuator configured to open and to close the shutter.

8. The optical disc recording and/or reproducing apparatus according to claim 7, further comprising:
a temperature sensor; and
the shutter configured to perform a movement to open at least a part of the shielded through portion when the opening is in the closed state and the temperature detected by the temperature sensor exceeds a threshold value.

9. The optical disc recording and/or reproducing apparatus according to claim 1, wherein the shutter is configured to perform a movement to open at least a part of the covered through portion when the opening is in the closed state and the optical pickup is performing an operation which generates a significant amount of heat from the optical pickup.

10. The optical disc recording and/or reproducing apparatus according to claim 9, wherein the operation which generates a significant amount of heat from the optical pickup is recording.

11. The optical disc recording and/or reproducing apparatus according to claim 1, wherein at least part of the through hole is provided on the disc tray at a position corresponding to the outer peripheral side of the optical disc.

12. An optical pickup cooling method of an optical disc recording and/or reproducing apparatus including:
a cabinet provided with an opening,
an opening/closing unit configured to open and close the opening,
a disc tray provided with a through portion at a part thereof,
an optical disc driving unit configured to rotate an optical disc on one of the surfaces of the disc tray at a predetermined distance from the disc tray,
an optical pickup reciprocatingly movable on the side of the other surface of the disc tray and configured to irradiate an optical beam to the optical disc and to detect a reflected beam through the through portion, and
a shutter configured to cover at least a part of the through portion, wherein said method comprises:
shielding at least a part of the through portion with the shutter so as to cover at least a part of the optical pickup, or opening at least a part of the shielded through portion according to the opened/closed state of the opening.

13. The optical pickup cooling method according to claim 12, comprising:
positioning the shutter to cover at least a part of the through portion so as to cover at least a part of the optical pickup when the opening is in the opened state; and positioning the shutter to open at least a part of the through portion when the opening is in the closed state.

14. The optical pickup cooling method of an optical disc recording and/or reproducing apparatus according to claim 12, wherein the optical disc recording and/or reproducing apparatus further comprising an actuator which opens and closes the shutter, and a temperature sensor, wherein the method further comprising:
opening at least a part of the covered through portion when the opening is in the closed state and the temperature detected by the temperature sensor exceeds a threshold value.

15. The optical pickup cooling method of an optical disc recording and/or reproducing apparatus according to claim 12, comprising:
positioning the shutter to open at least a part of the covered through portion when the opening is in the closed state and when the optical pickup is performing an operation which generates a significant amount of heat.

16. The optical pickup cooling method of an optical disc recording and/or reproducing apparatus according to claim 15, wherein the operation which generates a significant amount of heat by the optical pickup is recording.
